(19) United States
(12) Patent Application Publication
(10) Pub. No.: US 2025/0291060 A1
(43) Pub. Date: Sep. 18, 2025

(54) IMAGING SYSTEM

(71) Applicant: SICK AG, Waldkirch (DE)

(72) Inventors: Josef BAAK, Waldkirch (DE); Govinda KEMPERMANN, Waldkirch (DE); Michael NIERLICH, Waldkirch (DE); Simon BRAUN, Waldkirch (DE); Jan GERBER, Waldkirch (DE); Marc BLATTMANN, Waldkirch (DE)

(21) Appl. No.: 19/080,766

(22) Filed: Mar. 14, 2025

(30) Foreign Application Priority Data
Mar. 15, 2024 (DE) 102024107477.9

(51) Int. Cl. G01S 17/894; G01S 7/481; G01S 7/484; G01S 7/4865; H04N 25/768

(52) U.S. Cl. CPC G01S 17/894; G01S 7/4813; G01S 7/484; G01S 7/4865; H04N 25/768

(57) ABSTRACT

The invention relates to an imaging system comprising at least one camera module and one evaluation module, wherein the camera module comprises a time-of-flight-based 3D image sensor for generating 3D image data and a 2D camera for generating 2D image data, wherein the camera module and the evaluation module are connected to one another via only one connection cable, wherein an energy supply of the camera module takes place via the connection cable and the camera module is configured to transmit the 3D image data and the 2D image data to the evaluation module via the connection cable, wherein the evaluation module is configured to process the 3D image data and the 2D image data.

The present invention relates to an imaging system comprising at least one camera module and one evaluation module, wherein the camera module comprises a time-of-flight-based 3D image sensor for generating 3D image data and a 2D camera for generating 2D image data.

Imaging systems that combine different methods for imaging are required in various industrial applications. Thus, a zone to be monitored can, for example, be simultaneously monitored by means of a conventional camera, which generates a 2D image, and a depth sensor. Depth information can then be generated by the depth sensor, i.e., for example, the aforementioned 3D image sensor, whereby industrial processes can e.g. be monitored more accurately.

The camera modules of such imaging systems can also be designated as sensor heads, wherein the sensor heads should be formed as small and compact as possible to ensure their usability in as many scenarios as possible. Furthermore, there is the requirement that the connection of the sensor heads/camera modules to the evaluation module is to be accomplished as easily as possible to also be able to use the camera module at the end of a robot arm (so-called “end-of-arm” application), for example.

The underlying object of the invention can therefore be viewed as providing an imaging system comprising a compact camera module that can be easily connected to an evaluation module.

This object is satisfied by an imaging system according to claim 1.

The imaging system according to the invention comprises at least one camera module and one evaluation module, wherein the camera module comprises a time-of-flight based 3D image sensor for generating 3D image data and a 2D camera for generating 2D image data. In this respect, the camera module and the evaluation module are connected to one another via only one connection cable, wherein an energy supply of the camera module takes place (in particular solely) via the connection cable and the camera module is configured to transmit the 3D image data and the 2D image data to the evaluation module (in particular solely) via the connection cable. Finally, the evaluation module is configured to process the 3D image data and the 2D image data.

According to the invention, only a single connection cable is therefore required for the electrical connection (i.e. for the data connection and the energy supply) of the camera module to the evaluation module, which significantly simplifies the connection of the camera module to the evaluation module. In particular in the above-mentioned “end-of-arm” applications or in areas that are difficult to access, the connection of the camera module can thereby be significantly simplified.

According to the invention, both the energy supply of the camera module and the transmission of the image data take place via the only one single connection cable. To enable such a combination of the transmission via the connection cable, it is necessary to configure the camera module in an energy-saving manner and to transfer the processing of the image data to the evaluation module. Transferring the functionality to the evaluation module not only results in energy savings, but the camera module can also be made smaller and more compact, which is likewise advantageous for the industrial applications mentioned.

The 3D image data mentioned are to be understood as image data that are generated by the 3D image sensor and that in particular include depth information, for example, i.e. the distance of an object represented in the image data from the 3D image sensor. The 2D image data can be “conventional” image data that represent a conventional photographic two-dimensional image. The 2D image data can, for example, comprise color information or gray value information for a plurality of image pixels.

The camera module and the evaluation module are only connected to one another via the one connection cable. This means that the energy supply of the camera module by the evaluation module preferably takes place solely via the one connection cable. Equally preferably, only the one connection cable is solely used to transmit the 2D image data and the 3D image data from the camera module to the evaluation module. It is indeed possible for the camera module and the evaluation module to be attached to a common structure, for example an autonomously driving vehicle. However, the camera module and the evaluation module are attached separately from one another, and preferably at different locations, to the common structure and, as stated, the communication and the energy supply only take place via the connection cable. Alternatively or additionally, the evaluation module can also be arranged in a fixed position, whereas the camera module is moved, for example on a fastening of the camera module to a robot arm.

The processing of the 3D image data and the 2D image data in the evaluation module is in particular to be understood as the 3D image data and the 2D image data being fused with one another, for example, to additionally store the 2D image with depth information. The processing can, for example, also be understood as an object detection or an object tracking taking place in the 3D image data and/or the 2D image data.

Advantageous further developments of the invention are specified in the description, in the drawings and in the dependent claims.

According to a first embodiment, the evaluation module is configured to transmit operating information to the camera module via the connection cable, wherein the operating information preferably includes a configuration for the camera module and/or a trigger signal for triggering image recordings. Therefore, there is preferably also a return channel between the evaluation module and the camera modules or the camera module, via which return channel the evaluation module can transmit data to the camera module.

The configuration transmitted from the evaluation module to the camera module can, for example, be settings regarding which image size the 3D image sensor and/or the 2D camera should provide, which color depth the 2D camera should be set to and/or which scanning frequency and/or which depth range should be used by the 3D image sensor.

Due to said trigger, at least one of the cameras, i.e. either the 3D image sensor or the 2D camera, can be caused to record image data and to transmit the latter to the evaluation module. Via the trigger, the evaluation module can therefore control when the 3D image sensor and/or the 2D camera generates/generate image data.

According to a further embodiment, the camera module is configured to feed the trigger signal directly to one of the 3D image sensor and the 2D camera and to feed the trigger signal with a delay to the other of the 3D image sensor and the 2D camera. As described, the trigger signal initiates the image recording, i.e. ultimately the generation of the 3D image data and/or the 2D image data. The trigger signal can originate from the evaluation module so that the image generation can be linked to external events, for example. The trigger signal can in particular be generated at regular intervals, in particular constant intervals. In this respect, the generation of the trigger signal is generally also possible via the camera module.

For example, the 3D image sensor can receive the trigger signal directly or without a delay and can thus start the generation of 3D image data without a delay. The 2D camera can then only start the generation of the 2D image data with a delay, in particular by a predetermined delay period. Due to the delay, the data transmission can be improved via the connection cable, as will be stated in more detail below.

Alternatively, it is also possible for the 3D image sensor and the 2D camera to receive the trigger signal at the same time, whereby a simultaneous image recording then takes place and the generation of the 3D image data and the 2D image data is started at the same time.

According to a further embodiment, a delay unit is provided in the camera module and delays the trigger signal for the 3D image sensor or the 2D camera. In this respect, the delay of the trigger signal caused by the delay unit is selected such that the image data generated without a delay have already been at least partly (or completely) transmitted to the evaluation module via the connection cable. This means that the 3D image data of the 3D image sensor are, for example, generated directly without a delay and are also transmitted directly via the connection cable to the evaluation module. The 2D camera only receives the trigger signal and starts generating the 2D image data once the 3D image data have been at least partly or completely transmitted. Here, the advantage results that the transmission capacity of the connection cable can be fully utilized for the 2D image data, for example, if the 3D image data have already been completely transmitted. The transmission via the connection cable is thus simplified. The advantage also results that no buffer memory (or only a smaller buffer memory) has to be provided in the camera module, e.g. for the usually very large data amount of 2D image data, whereby the camera module can in turn be made smaller, more compact and more energy-saving.

It is understood that the 2D camera can also receive the trigger signal without a delay, whereas the 3D image sensor then receives the trigger signal with a delay. In this case, the 2D image data are then preferably transmitted first and the 3D image data are only subsequently transmitted via the connection cable.

In particular, the delay that is generated by the delay unit can be set to a fixed or constant value. This is in particular possible if the data rates and the size of the image data that are generated by the 3D image sensor and the 2D camera are known. The data rate at which the transmission via the connection cable is possible can likewise be known and is also designated as the maximum transmission data rate herein.

Alternatively, it is also possible to determine the respective data rates and/or the size of the image data from the current configuration of the camera module and to calculate the delay period during operation.

Further alternatively or additionally, it is also possible that the delay unit can determine whether image data are transmitted via the connection cable and/or which image data are transmitted via the connection cable. The delay unit can then be configured to forward the trigger signal (to that camera which has not yet generated any image data) from a predetermined size of the image data and/or after the end of the image data, for example.

According to a further embodiment, a serializer is provided in the camera modules and/or a deserializer is provided in the evaluation module, wherein the serializer is connected to the 3D image sensor and/or the 2D camera via one data connection in each case, wherein the serializer integrates, i.e. for example converts, the 3D image data and/or the 2D image data into a serial data stream and transmits said 3D image data and/or 2D image data via the connection cable.

The deserializer in particular receives the serial data stream via the connection cable and extracts the 3D image data and/or the 2D image data from the serial data stream. In other words, the deserializer reconstructs the 3D image data and/or the 2D image data from the serial data stream.

The serializer, the deserializer and the connection cable can in particular form a GMSL system (Gigabit Multimedia Serial Link system) or can be based on such a system.

The above-explained delay of the trigger signal can in particular result in the 3D image data and the 2D image data successively arriving at the serializer so that preferably no data congestion occurs at the serializer so that a maximum throughput can be achieved via the connection cable. Moreover, it can be ensured that no image data are lost.

Furthermore, it can be ensured by the deliberate delay that the image data (i.e. each image) have a unique and correct time stamp. This can facilitate the correct processing of the image data in the evaluation module. Furthermore, it can be ensured by the delay that the maximum bandwidth or transmission rate of the connection cable is not exceeded at any point in time.

According to a further embodiment, the serializer and/or the deserializer is/are configured to transmit the 3D image data and the 2D image data in separate virtual channels via the connection cable. A simplified handling can hereby result that in particular consists of a simplified integration and extraction of the image data into/from the serial data stream. The serializer and/or the deserializer can provide a corresponding protocol that makes the virtual channels possible.

According to a further embodiment, the 3D image sensor is configured to generate the 3D image data at a first maximum data rate and the 2D camera is configured to generate the 2D image data at a second maximum data rate. Moreover, a data transmission via the connection cable is possible at a maximum transmission data rate. In particular, the first data rate and/or the second data rate is/are individually greater than the maximum transmission data rate. Alternatively or additionally, the first and second maximum data rate taken together are greater than the maximum transmission data rate.

The maximum data rate is to be understood as the maximum data rate which the 3D image sensor or the 2D camera can achieve, for example, at the maximum resolution, maximum scan rate, maximum color depth, maximum scanning range, etc. The maximum data rate can be higher than the maximum transmission data rate. Therefore, more data can be generated, at least temporarily, by the 3D image sensor or the 2D camera than can be transmitted via the connection cable in one unit of time.

If the first and the second maximum data rate are only greater than the maximum transmission data rate when taken together, the aforementioned delay, which leads to a successive transmission, can already be sufficient in order not to exceed the maximum transmission data rate. If the first and/or the second maximum data rate alone is also greater than the maximum transmission data rate, additional measures can also be taken, as stated below.

According to a further embodiment, the 2D camera is configured to generate image data only for a part of its field of view. The 2D camera can therefore be configured to perform a so-called “cropping”. The 2D camera preferably supports the cropping natively, i.e. only a part of its image sensor is read out, for example. Due to such a cropping already at the level of the image sensor, an energy saving can take place since no unnecessary data are generated. Moreover, a saving of transmission bandwidth can take place. Furthermore, it is possible to read out different parts of the image sensor successively, i.e. to display different image regions in different images. For example, the image region to be read out can be changed after a respective trigger signal so that the evaluation module is then put into a position to reconstruct an overall image of the monitored zone from the 2D image data.

According to a further embodiment, a buffer memory for 3D image data, which buffer memory is connected to the 3D sensor, is provided in the camera modules, wherein the camera module is configured to write the 3D image data to the buffer memory at a higher data rate than the data rate at which the buffer memory transmits the 3D image data to the serializer and/or to the evaluation module. The 3D sensor usually delivers a very large amount of data in a very short time, so-called bursts. This maximum data rate of the 3D sensor can significantly exceed the maximum transmission data rate. The data rate can then be reduced via the buffer memory; therefore, the transmission of the 3D image data via the connection cable is preferably stretched out over time.

In particular, the 3D image sensor can output the 3D image data via a MIPI interface, in particular to the buffer memory. A slowed-down output of the 3D image data can then take place from the buffer memory.

The buffer memory can in particular be part of a processor, for example a signal processor, in particular a digital signal processor, DSP. The processor further in particular makes a change to the 3D image data, for example, a compression and/or an extraction of the depth information. The depth information can then be at least partly or completely replaced by the previous 3D image data, wherein the 3D image data amended and/or replaced in this way are transmitted via the connection cable.

For example, the 3D image sensor comprises an integrated processing device, e.g. a DSP, that calculates the depth information from 3D raw data (measured phase information of the transmitted and subsequently backscattered light). The 3D raw data can (initially) be the 3D image data. The processing device can furthermore filter out invalid pixel information based on changeable criteria and can perform pre-processing steps (before the conversion into depth information) and post-processing steps that can in particular be parameterized by the evaluation module. The processing device can add status information about the pixel data (e.g. metadata, confidence data) to the 3D image data.

By calculating the depth data from the 3D raw data, the amount of data can be significantly reduced, for example by a factor of 9. The transmission of the 3D image data via the connection cable can thereby be simplified.

The statements regarding the buffer memory and/or the processor also apply accordingly to the 2D image data that can likewise be output at a slower rate by a corresponding buffer memory. In both cases, the size of the buffer memory can be dimensioned such that the buffer memory never fills up.

However, the 2D image data are preferably transmitted via the connection cable in an unchanged form and/or in particular not delayed by a buffer memory provided for a delay.

With the exception of the compression of the 3D image data, preferably no change to the image data can take place in the camera module, whereby the camera module can in turn be made more compact and energy-saving. Preferably, no change to the image data takes place in the camera module at all that has effects on the information contents of the 3D and/or 2D image data (the conversion by means of the serializer does not change the information content of the image data).

In particular, the delay device can, for example, also be integrated into the processor so that the processor also generates the delay.

According to a further embodiment, the 3D image data and the 2D image data have different formats and/or different sizes, wherein the 3D image data and/or the 2D image data are preferably present in a data format that occupies whole bytes in each case. The transmission of the different data formats creates additional complexity that is, however, taken into account by the aforementioned measures of the virtual channels and the transmission that takes place successively. By using data formats that use whole bytes in each case, for example RAW16 or RAW8, the bandwidth in the connection cable can be fully utilized.

According to a further embodiment, the camera module comprises an energy store, in particular a capacitor bank, that is configured to store electrical energy received via the connection cable and to output the stored electrical energy in the case of an energy requirement of the camera module that exceeds the electrical power transmitted via the connection cable, wherein the energy store preferably has a limiting circuit that limits a speed at which the energy store is charged.

The energy transmission via the connection cable is limited, wherein the camera module can in particular require more electrical power during the image recording than can be made available via the connection cable. In such a case, the additional energy required can then be drawn from the energy store at short notice. Once the image recording is complete, the energy store can be recharged to then be able to provide electrical energy during the next image recording.

The limiting circuit prevents an overloading of the connection cable. The limiting circuit can be configured to enable the charging of the energy store, for example, at a constant or permanently set maximum value of a charging current.

Alternatively or additionally, the limiting circuit can comprise a sensor system that compares the current energy consumption of the camera module with the maximum possible energy amount that can be supplied by the connection cable and uses the difference to charge the energy store (the charging current is then set accordingly). In this way, an optimal utilization of the energy transmission via the connection cable can be achieved.

The camera module is preferably adapted such that the averaged energy consumption of the camera module is less than the maximum energy quantity that can be supplied via the connection cable. The averaged energy consumption can, for example, be determined over multiple minutes during a regular operation of the imaging system. In particular, the averaged energy consumption is at least 60%, in particular at least 70%, further in particular at least 80%, of the maximum energy amount that can be supplied via the connection cable. On the other hand, the averaged energy consumption is, however, at most 80%, in particular at most 90%, in particular at most 95%, of the maximum energy amount that can be transmitted via the connection cable. On average, the energy consumption may not exceed the maximum energy amount that can be supplied via the connection cable since otherwise there will be no energy reserves left to charge the energy store.

For this reason, the camera module should be operated in as energy-saving a manner as possible. For example, it can be provided that the 2D camera performs a pixel binning and/or the 3D sensor performs a reduction of the transmission power for a transmitted optical signal (i.e. the transmission light), in particular if the monitored zone of the 3D sensor is reduced. Further energy-saving measures are naturally likewise possible.

To transmit the electrical energy via the connection cable, a respective separating filter can be provided in the camera module and/or in the evaluation module to separate the data transmitted via the connection cable, i.e. the image data, from a signal of the energy supply. For example, the data can be filtered out by means of a high-pass filter, whereas the energy supply can take place via a low-pass filter.

According to a further embodiment, the connection cable is a coaxial cable or a cable comprising a single shielded twisted pair line. The coaxial cable can in particular only have a shielding and a neutral conductor, in particular with respect to the components that are electrically connected to both the camera module and the evaluation module. In a corresponding manner, the twisted pair line can likewise only have two conductors and possibly a shielding. Only the neutral conductor and the shielding or only the twisted pair lines and their shielding are preferably used for the data transmission and/or the energy transmission, otherwise no additional electrical connections are used.

The ground or the shielding is preferably connected to the housing of the camera module and/or of the evaluation module in a direct manner or with low impedance. The ground or the shielding can in this respect be connected to a protective conductor connection (PE connection). In this way, the EMC compatibility of the imaging system can be increased.

As already indicated above, the camera module and the evaluation module are arranged separately from one another and are preferably formed in separate housings. The connection cable can have a minimum length of 0.5, 1 or 2 m, for example. The connection cable can have a maximum length of 15 m, 20 m or 30 m, for example. The evaluation module and the camera module preferably each have a plug-in possibility, for example at their housings, for a connector of the connection cable. The connection cable can therefore in particular have two connectors, one for the camera module and one for the evaluation module. The connectors can be releasably attached to the plug-in options.

According to a further embodiment, the 3D image sensor is a TOF sensor (Time of Flight Sensor) or an iTOF sensor (indirect Time of Flight Sensor), in particular a laser scanner or a LIDAR (Light Detection and Ranging). The 3D image sensor can in particular have a transmission light source that transmits transmission light in a monitored zone. In the monitored zone, the transmission light can be incident on objects that remit the transmission light towards the 3D image sensor, i.e. reflect the transmission light. Reflected transmission light detected by the 3D image sensor can then be (directly or indirectly) used to evaluate the time of flight in order to determine the distance from the object. The transmission light can in this respect be transmitted into different areas of the monitored zone in order thus to generate a depth image of the monitored zone with a plurality of pixels.

According to a further embodiment, the 2D camera is a monochrome camera or a color camera and preferably at least has a resolution of 4 megapixels, 8 megapixels or 12 megapixels. The 2D camera can in particular have an optics with an image sensor disposed behind it. An image of the monitored zone is projected onto the image sensor by the optics. The image sensor can have the aforementioned resolution of at least 4 megapixels, 8 megapixels or 12 megapixels and can be configured as a CCD or CMOS sensor, for example.

According to a further embodiment, the 3D image sensor and the 2D camera have the same field of view, an overlapping field of view or mutually adjoining fields of view. The above-mentioned monitored zone can be a partial region of the field of view in each case. The field of view refers to the area that can be mapped in the image data. Preferably, for example, at least 90% of the solid angle of the field of view of the 3D sensor and the 2D camera are identical. The visual axes, i.e. the alignment, of the 3D image sensor and the 2D camera are preferably parallel.

A further subject of the invention is a camera module comprising a time-of-flight-based 3D image sensor for generating 3D image data and a 2D camera for generating 2D image data, wherein the camera module is configured for operation with only one connection cable, wherein an energy supply of the camera module takes place, preferably solely, via the connection cable and the camera module is configured to transmit the 3D image data and the 2D image data, preferably solely, via the connection cable.

A further subject of the invention is, moreover, an extended imaging system comprising an evaluation module to which two or more camera modules of the above-mentioned kind are each connected via a separate connection cable. The evaluation module can in particular be a so-called edge device. The evaluation module can have a computing device for processing the image data, wherein the evaluation module can, for example, comprise a plurality of deserializers in order to connect a plurality of the camera modules to the evaluation module in parallel and to receive image data from a plurality of camera modules in parallel.

Finally, the invention also relates to a method of operating an imaging system comprising at least one camera module and one evaluation module, wherein the camera module comprises a time-of-flight-based 3D image sensor for generating 3D image data and a 2D camera for generating 2D image data, wherein the camera module and the evaluation module are connected to one another via only one connection cable, wherein an energy supply of the camera module takes place, preferably solely, via the connection cable and the camera module transmits the 3D image data and the 2D image data to the evaluation module, preferably solely, via the connection cable. In this respect, the evaluation module processes the 3D image data and the 2D image data.

The statements regarding the imaging system according to the invention apply accordingly to the camera module according to the invention, the imaging system extended according to the invention and the method according to the invention. This in particular applies with respect to advantages and preferred embodiments.

It is furthermore understood that the features and embodiments mentioned herein can be combined with one another, unless explicitly stated otherwise.

The invention will be described purely by way of example with reference to the drawings in the following. There are shown:

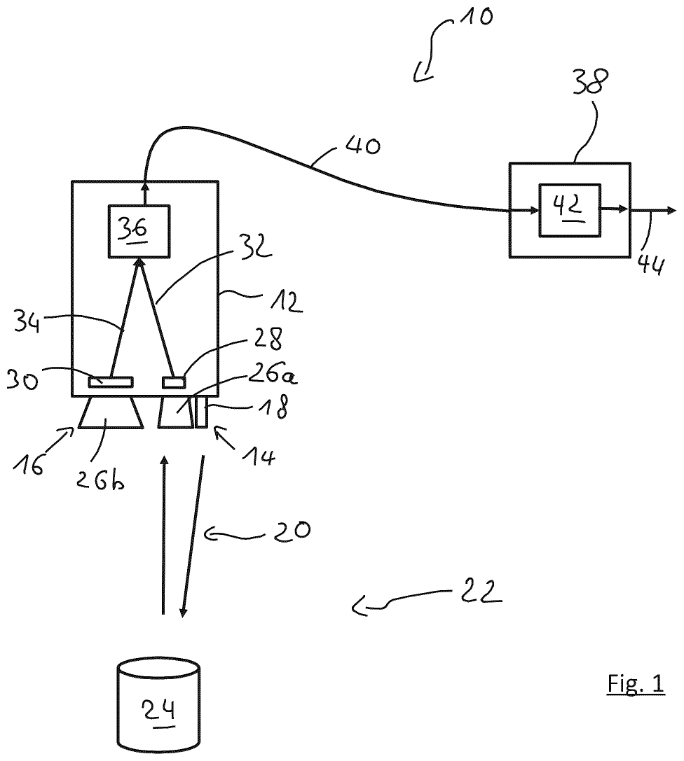

FIG. 1 schematically, an imaging system comprising one camera module and one evaluation module;

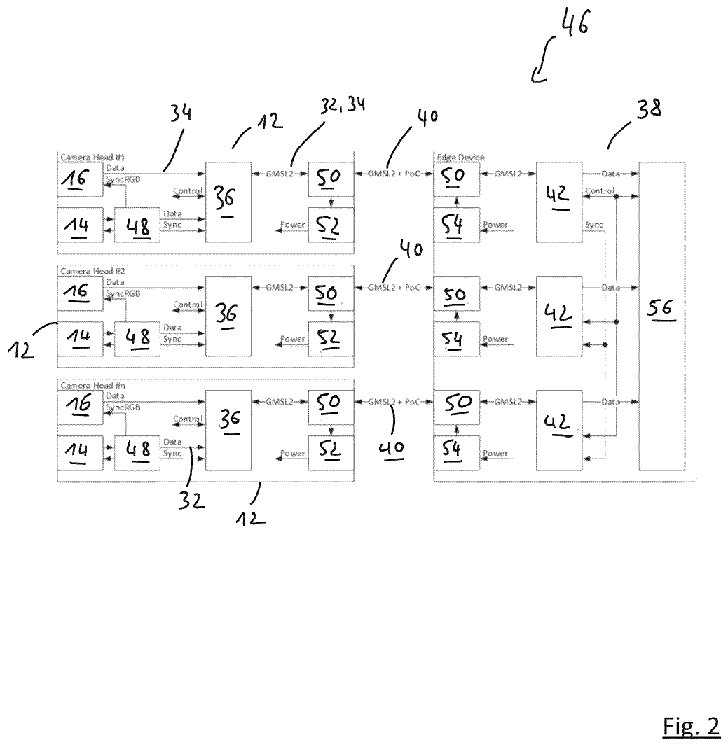

FIG. 2 an extended imaging system comprising three camera modules that are connected to the same evaluation module.

FIG. 1 shows an imaging system 10 comprising a camera module 12 (also called a sensor head). The camera module 12 comprises a time-of-flight-based 3D image sensor 14 and a 2D camera 16.

The 3D image sensor 14 comprises a light transmitter 18 that transmits transmission light 20 into a monitored zone 22. An object 24 arranged in the monitored zone 22 remits the transmission light 20 that is then directed from the 3D image sensor to an image sensor 28 by means of a lens 26a. The 2D camera 16 likewise comprises a lens 26b and a further image sensor 30.

In this way, the 3D image sensor 14 and the 2D camera 16 generate 3D image data 32 and 2D image data 34 that are transmitted to a serializer 36.

The imaging system 10 further comprises an evaluation module 38 that is connected to the camera module 12 via a single connection cable 40, in particular in the form of a coaxial cable.

The serializer 36 is coupled to the connection cable 40 to transmit the 3D image data 32 and the 2D image data 34 to the evaluation module 38 via the connection cable 40.

A deserializer 42 is provided in the evaluation module 38 and reconstructs the 3D image data 32 and the 2D image data 34 from the data transmitted via the connection cable 40. A processing of the 3D image data 32 and the 2D image data 34 furthermore takes place in the evaluation module 38, wherein a processing result 44 is output via an interface (not shown) of the evaluation module 38.

FIG. 2 shows an extended imaging system 46 comprising three camera modules 12, each of which is connected to the same evaluation module 38 only via a respective connection cable 40. In FIG. 2, even more details of the internal design of the camera modules 12 and the evaluation module 38 are shown.

The camera modules 12 are identically designed in each case. It can be seen that the 3D image sensor 14 is coupled to a processor 48 in the form of a digital signal processor. The processor 48 is in turn connected to the serializer 36. The processor 48 also serves as a delay unit and receives, via the serializer 36, a trigger signal (here called Sync) which the processor 48 forwards to the 2D camera 16 with a delay (here called SyncRGB). Alternatively, the 3D image sensor 14 itself can also serve as a delay unit and receive the trigger signal.

The processor 48 also serves as a buffer memory for the 3D image data 32, thereby slowing down the transmission of the 3D image data 32 from the 3D image sensor 14 to the serializer 36.

The serializer 36 is electrically coupled to the connection cable 40, wherein the connection cable is furthermore electrically connected to a separating filter 50 that separates data transmitted via the connection cable 40 and the electrical energy supply from one another. The electrical energy supply is represented by an energy store 52 in FIG. 2. The energy store 52 comprises a capacitor bank and a limiting circuit that limits the rate of the charging of the capacitor bank.

On the side of the evaluation module 38, a single separating filter 50 is in turn provided for each connection cable 40. The separating filter 50 is coupled to an energy supply 54 that feeds electrical energy for the camera modules 12 into the connection cable 40.

The data received via the connection cable 40 are also transmitted by the separating filters 50 to three deserializers 42 that forward the received 3D image data 32 and 2D image data 34 to a computing device 56 of the evaluation module 38. The computing device 56 in turn generates configuration signals (designated as control in FIG. 2) and the trigger signal. The configuration and the trigger signal can be transmitted from the evaluation module 38 to the camera module 12 via the connection cable 40. As shown in FIG. 2, the trigger signal can be identical for all the camera modules 12 so that the image generation is triggered at the same time for all the camera modules 12.

If the trigger signal is simultaneously fed to all the camera modules 12, one of the camera modules 12 can act as the master. Since the camera modules 12 transmit transmission light 20 via the light transmitters 18, there is the possibility that different camera modules 12 interfere with one another. To avoid this, the remaining camera modules 12 synchronize to the master's clock, wherein each 3D image sensor 14 of the remaining camera modules 12 uses a different delay to generate the respective 3D image data 32. The different delay can be generated by the 3D image sensors 14. Alternatively, it is also possible for the evaluation module 38 to transmit the trigger signal to the various camera modules 12 at different points in time, wherein the delay between the individual camera modules 12 is preferably the same.

Due to the transmission of the image data and the electrical energy for the camera modules 12 by means of only one connection cable 40 in each case, a flexible and simple use of the imaging systems 10 can be made possible. By using a single evaluation module 38 for a plurality of camera modules 12, the effort when using a plurality of camera modules 12 can be reduced even further.

### REFERENCE NUMERAL LIST

10 imaging system
12 camera module
14 3D image sensor
16 2D camera
18 light transmitter
20 transmission light
22 monitored zone
24 object
26 lens
28 image sensor
30 image sensor
32 3D image data
34 2D image data
36 serializer
38 evaluation module
40 connection cable
42 deserializer
44 processing result
46 extended imaging system
48 processor
50 separating filter
52 energy store
54 energy supply
56 computing device

1. An imaging system comprising at least one camera module and one evaluation module, wherein the camera module comprises a time-of-flight-based 3D image sensor for generating 3D image data and a 2D camera for generating 2D image data,
wherein the camera module and the evaluation module are connected to one another via only one connection cable, wherein an energy supply of the camera module takes place via the connection cable and the camera module is configured to transmit the 3D image data and the 2D image data to the evaluation module via the connection cable,
wherein the evaluation module is configured to process the 3D image data and the 2D image data.

2. The imaging system according to claim 1,
wherein the evaluation module is configured to transmit operating information to the camera module via the connection cable.

3. The imaging system according to claim 2,
wherein the operating information includes a configuration for the camera module and/or a trigger signal for triggering image recordings.

4. The imaging system according to claim 1,
wherein the camera module is configured to feed the trigger signal directly to one of the 3D image sensor and the 2D camera and to feed the trigger signal with a delay to the other of the 3D image sensor and the 2D camera.

5. The imaging system according to claim 1,
wherein a delay unit is provided in the camera module and delays the trigger signal for the 3D image sensor or the 2D camera, wherein the delay of the trigger signal caused by the delay unit is selected such that the image data generated without a delay have already been at least partly or completely transmitted to the evaluation module via the connection cable.

6. The imaging system according to claim 1,
wherein a serializer is provided in the camera module and/or a deserializer is provided in the evaluation module, wherein the serializer is connected to the 3D image sensor and/or the 2D camera via one data connection in each case, wherein the serializer integrates the 3D image data and/or the 2D image data into a serial data stream and transmits said 3D image data and/or 2D image data via the connection cable,
wherein the deserializer receives the serial data stream via the connection cable and extracts the 3D image data and/or the 2D image data from the serial data stream.

7. The imaging system according to claim 6,
wherein the serializer and/or the deserializer is/are configured to transmit the 3D image data and the 2D image data in separate virtual channels via the connection cable.

8. The imaging system according to claim 1,
wherein the 3D image sensor is configured to generate the 3D image data at a first maximum data rate and the 2D camera is configured to generate the 2D image data at a second maximum data rate, wherein a data transmission via the connection cable is possible at a maximum transmission data rate,
wherein the first data rate and/or the second data rate is/are individually greater than the maximum transmission data rate, and/or wherein the first and second maximum data rate taken together are greater than the maximum transmission data rate.

9. The imaging system according to claim 1,
wherein the 2D camera is configured to generate 2D image data only for a part of its field of view.

10. The imaging system according to claim 1,
wherein a buffer memory for 3D image data is provided in the camera module, the buffer memory being connected to the 3D image sensor,
wherein the camera module is configured to write the 3D image data to the buffer memory at a higher data rate than the data rate at which the buffer memory transmits the 3D image data to the serializer.

11. The imaging system according to claim 1,
wherein the 3D image data and the 2D image data have different formats and/or different sizes, wherein the 3D image data and/or the 2D image data are present in a data format that occupies whole bytes in each case.

12. The imaging system according to claim 1,
wherein the camera module comprises an energy store that is configured to store electrical energy received via the connection cable and to output the stored electrical energy in the case of an energy requirement of the camera module that exceeds the electrical power transmitted via the connection cable, wherein the energy store has a limiting circuit that limits a speed at which the energy store is charged.

13. The imaging system according to claim 12,
wherein the energy store is a capacitor bank.

14. The imaging system according to claim 1,
wherein the connection cable is a coaxial cable or a cable comprising a single shielded twisted pair line.

15. The imaging system according to claim 1,
wherein the 3D image sensor is a TOF sensor or an iTOF sensor.

16. The imaging system according to claim 15,
wherein the iTOF sensor is a laser scanner or a LIDAR.

17. The imaging system according to claim 1,
wherein the 2D camera is a monochrome camera or a color camera.

18. The imaging system according to claim 17,
wherein the 2D camera at least has a resolution of 4 megapixels or 8 megapixels.

19. The imaging system according to claim 1,
wherein the 3D image sensor and the 2D camera have the same field of view, an overlapping field of view or mutually adjoining fields of view.

20. A camera module comprising a time-of-flight-based 3D image sensor for generating 3D image data and a 2D camera for generating 2D image data,
wherein the camera module is configured for the operation with only one connection cable, wherein an energy supply of the camera module takes place via the connection cable and the camera module is configured to transmit the 3D image data and the 2D image data via the connection cable.

21. A method of operating an imaging system comprising at least one camera module and one evaluation module, wherein the camera module comprises a time-of-flight-based 3D image sensor for generating 3D image data and a 2D camera for generating 2D image data,
wherein the camera module and the evaluation module are connected to one another via only one connection cable, wherein an energy supply of the camera module takes place via the connection cable and the camera module transmits the 3D image data and the 2D image data to the evaluation module via the connection cable,
wherein the evaluation module processes the 3D image data and the 2D image data.
